(19) United States
(12) Patent Application Publication
(10) Pub. No.: US 2011/0089296 A1
(43) Pub. Date: Apr. 21, 2011

(54) Adjustable support

(76) Inventor: Denis Joanisse, Harrington (CA)

(21) Appl. No.: 12/924,863

(22) Filed: Oct. 8, 2010

Related U.S. Application Data
(60) Provisional application No. 61/279,182, filed on Oct. 19, 2009.

(51) Int. Cl. F16M 11/02

(52) U.S. Cl. 248/181.1

(57) ABSTRACT

An adjustable support for supporting a device such as a note pad. The support has a fixed cylindrical ball support, the top of the ball support having a part-spherical depression. The support includes a ball on the top of the ball support resting snugly but movably in the depression. A casing has a lower cylindrical portion snugly covering the ball support and an upper portion covering at least part of the ball and normally, in a locked position of the casing, retaining the ball on the ball support so the ball cannot move. There is an opening in the top of the upper portion of the casing, the device to be supported connected to the top of the ball through the opening. The casing is slidable on the ball support. A handle projects radially from the casing, aligned with the ball support. The handle can be rotated to move axially toward or away from the ball support to move the casing to unlock or lock the ball against movement. When the ball is unlocked for movement, the device being supported by the ball can be tilted and/or rotated by the operator to a desired position.

### BACKGROUND OF THE INVENTION

1. Technical Field

This invention relates to an adjustable support. The invention is also directed to adjustable guide means, particularly adjustable guide means for use with the adjustable support. The invention is particularly directed toward an adjustable support used to support a note pad or like device. The adjustable support is particularly useful in vehicles for use by the vehicle operator.

2. Background Art

Adjustable supports for note pads or like devices are known. Usually however the supports do not permit much adjustment to vary the position and/or attitude of the device being supported so that it would be in a comfortable position for use. Supports that have better adjustment usually require operation of at least two different controls to position the device in a comfortable location for the user. The adjustment process can be difficult particularly when the support is used in a vehicle.

Adjustable supports used in vehicles are subjected to vibration. If the components of the support become loose, due to wear, it becomes difficult to read a device supported by the support due to the vibrations transmitted to the device by the support from the vehicle. It becomes expensive to replace parts on the support to eliminate the vibrations.

### SUMMARY OF THE INVENTION

It is the purpose of the present invention to provide an adjustable support for a device such as a note pad that is simple and easy to use. It is a further purpose to provide an adjustable support that can be easily adjusted using a single handle. It is also the purpose of the present invention to provide an adjustable support that is relatively compact. It is a further purpose of the present invention to provide an adjustable guide means, particularly useful for the adjustable support but not limited thereto, that can be easily adjusted to compensate for wear to maintain a tight construction that minimizes the effect of vibrations. The present adjustable support, with the adjustable guide means, minimizes vehicle vibrations being transmitted to the device. With the single handle, the operator can, with one hand, adjust the support to move the support toward or away from him and can, with the handle, unlock part of the support carrying the device to be able to tilt and/or rotate the device to the desired angle and position and to lock it when the desired angle and position is obtained. The handle can be moved out of the way when not needed.

In accordance with the present invention, there is provided an adjustable support comprising a ball mounted on a ball support, the ball have connection means at its top to connect the ball to a device to be supported. The ball support is dished on the top to snugly receive the ball and is fixed to a slidable bottom plate. A casing snugly surrounds the ball support and extends up and partly over the ball to maintain the ball on the support and prevent its movement, and thus movement by the device supported thereon, by pressing down on it. The casing is slidable upwardly to unlock the ball allowing the ball to tilt and/or rotate, thus permitting rotation and/or tilting of the supported device by the operator. Cooperating cam means are provided on the ball support and the casing for moving the casing relative to the ball support. A single handle is provided for moving one of the cam means with respect to the other cam means to allow movement of the casing. Once the device has been properly positioned, the handle is used to move the casing against the ball to lock it in the desired position.

Adjustable guide means are provided for guiding a plate that is slidable relative to a base it rides on. The guide means, mounted on the plate, contact opposed sides of the base to guide the plate during its movement. If the guide means become worn, the guide means can be easily adjusted to compensate for the wear by moving the guide means nearer the sides of the base. The guide means are particularly useful with the present support means since it will be used mainly in vehicles which can vibrate the support means. A vibrating support means makes it difficult to read the device supported by the support means.

The invention is particularly directed to an adjustable support for supporting a device such as a note pad or the like. The support has a fixed cylindrical ball support, the top of which has a part spherical depression. A ball is loosely mounted on the top of the ball support resting snugly in the depression. The support has a casing having a lower cylindrical portion and an upper portion, the lower portion snugly covering the ball support and the upper portion covering at least part of the ball and normally, in a locked position of the casing, retaining the ball on the ball support so the ball cannot move. An opening is provided in the top of the upper portion of the casing, so that the device to be supported can be connected to the top of the ball through the opening. The casing is slidable on the ball support. Cooperating cam means are provided on the ball support and casing. Movement of one of the cam means relative to the other causes movement of the casing. Cam moving means are provided for moving the one cam means to be able to move the casing, and thus the upper portion of the casing away from its locked position on the ball to an unlocked position. This allows the ball to move thereby allowing rotation and/or tilting of the device supported by the ball to a desired position by the operator manipulating the device.

The invention is also particularly directed toward adjustable guide means for guiding a bottom plate slidably along a base, the base having two opposed side walls. The bottom plate has guide means on each of two opposed sides of the plate abutting the side walls on the base. Each guide means comprises a thin block with a circular hole extending through the block, and a screw extending through the hole into the bottom plate to attach the block flat onto the bottom plate. The center of the hole is offset with respect to the center of the block. When the block becomes worn, the block can be loosened and repositioned on the bottom plate to provide a tighter fit between the side walls on the base.

### DESCRIPTION OF SEVERAL VIEWS OF THE DRAWINGS

FIG. 1 is a perspective view of the support;

FIG. 2 is an exploded view of the support;

FIG. 3 is a cross section view of the support;

FIG. 4 is more detailed cross-section view of the support without the bottom plate and base;

FIG. 5 is a detail view showing the connection of the handle to the casing;

FIG. 6 is a plan view of the cam pin;

FIG. 7 is a perspective view of the base with the bottom plate on the base; and

FIG. 8 is plan view of one of the guides on the bottom plate

### DETAILED DESCRIPTION OF THE INVENTION

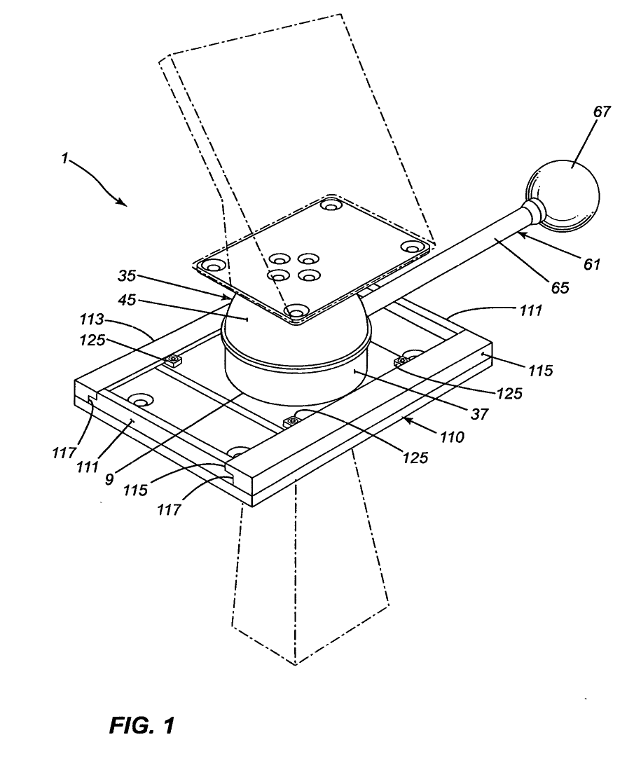

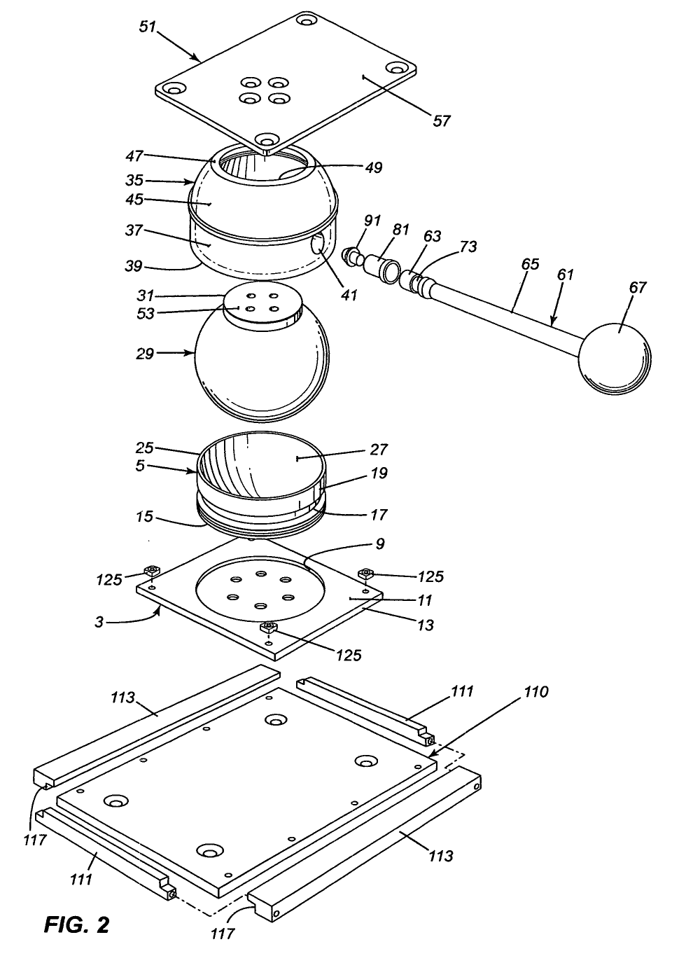

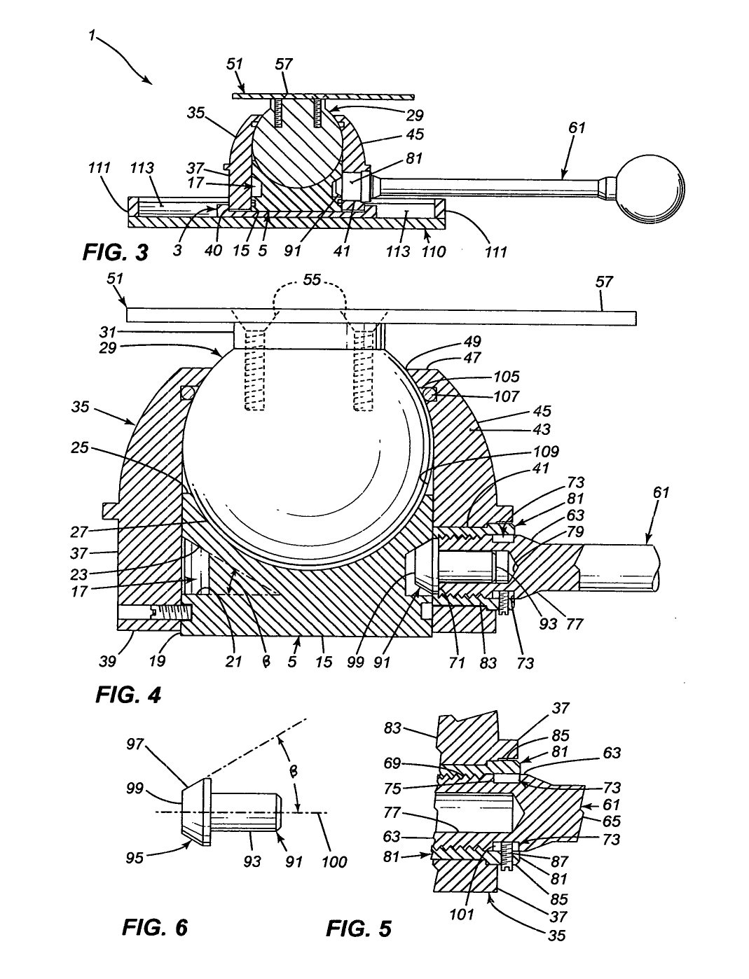

The support 1, as shown in FIGS. 1 to 3, has a bottom plate 3 on which is fixedly mounted a ball support 5. The ball support 5 has a generally cylindrical body shape. The bottom plate 3 is relatively thin and square with a shallow, cylindrical bore 9 in the center of the top surface 11 of the plate for receiving the bottom of the ball support 5. Screws, not shown, extend up from the bottom 13 of the plate 3 into the support 5 through its bottom 15 to securely hold the support 5 centered in the bore 9 on the plate 3. The heads of the screws are countersunk flush into the plate 3 so that the bottom 13 of the plate 3 is flat. There is a circumferential cam groove 17 in the outer circumferential side 19 of the ball support 5. The bottom side wall 21 of the groove 17, as shown in FIG. 4, is parallel to the bottom 15 of the support 5. The upper side wall 23 of the groove angles downwardly toward the bottom 15, from the outer side 19 of the support at an angle β to the bottom side wall 21. The top 25 of the support 5 is dished inwardly to provide a shallow, part-spherical, depression 27 to receive the bottom portion of a ball 29. The diameter of the ball 29 is the same as the diameter of the ball support 5. The ball 29 seats loosely yet snugly in the depression 27 of the ball support 5 and is free to rotate and tilt in the support 5. There is a short cylindrical extension 31 on the top of the ball 29.

A vertically movable casing 35 encloses the ball support 5 and partially encloses the ball 29 on the ball support. The casing 35 has a bottom cylindrical skirt portion 37 which encloses the ball support 5. The bottom edge 39 of the skirt portion 37 normally rests within the bore 9 on the plate 3 between the vertical wall 40 of the bore 9 and the side 19 of the ball support 5. The casing 35 has a cylindrical bore 41 through its wall 43 in about the center of is cylindrical skirt portion 37. The bore 41 is generally centered with respect to the cam groove 17 in the support 5 and opens into it. The casing 25 has an upper ball retaining portion 45, attached to and extending up from the top of the cylindrical skirt portion 37, the upper portion 45 tapering inwardly toward its top 47. The upper portion 45 is part spherical to fit closely on the ball when retaining it in the depression. The top 47 of the upper portion 45 of the casing is truncated and open as shown at 49. The upper portion of the ball 29 including its top cylindrical extension 31 extend through the opening 49. The casing 35 is free to slide up and down on the ball support 5.

A top mounting plate 51 is attached to the flat top 53 of the cylindrical extension 31 on the ball 29 with screws 55 that extend into the ball. The heads of the screws 55 are countersunk into the mounting plate 51 and the extension 31 so that the top 57 of the mounting plate 51 is flat. Attaching means, not shown, can be provided on the mounting plate 51 for using in attaching an electronic device, such as a note pad on the top 57 of the plate.

A handle 61 is attached to the casing 35. The handle 61 has a slightly enlarged, cylindrical, head 63 that is attached at one end to one end of a shaft 65, the other end of the shaft carrying a knob 67. The head 63 is threaded, as shown at 69, for most of its length from its front end 71. A shallow channel 73 with vertical side walls 75 circumscribes the head 63 adjacent its rear end 77. A blind, axial bore 79 extends into the head 63 from its front end 71. A sleeve 81 is fixedly mounted in the bore 41 of the skirt portion 37 of the casing 35. The interior of the sleeve 81 is threaded as shown at 83. The sleeve 81 projects slightly from the casing 35 when mounted in the bore 41. The outer portion of the sleeve 81 is enlarged with a shoulder 85. There is a small threaded bore 87 extending radially through the shoulder 85 of the sleeve 81. The interior of the sleeve 81 is aligned with the cam groove 17 in the ball support 5.

A cam pin 91 is mounted in the axial bore 79 in the head 63 of the handle 61. The cam pin 91 has a stem 93 which fits snugly in the bore 79, the stem 93 carrying a truncated, conical, cam 95 at its leading end. The cam pin 91 can be press-fit in the bore 79. The cam 95 rests against the front end 71 of the head 63 on the handle 61 when the stem 93 is mounted in the head 63. The side 97 of the cam 95 tapers inwardly toward the front 99 of the cam and extends at an angle β to the axis 100 of the pin 91 which angle is the same angle β the upper side wall 23 of the cam groove 17 in the support 5 makes with the bottom side wall 21 of the groove.

The handle 61, with the cam pin 91 in place, is mounted on the casing 35 by screwing the head 63 of the handle into the sleeve 81. The handle 61 is screwed in until the side 97 of the cam 95 on the pin 91 abuts the tapered side wall 23 of the cam groove 17. In this position, the channel 73 in the head 63 of the handle 61 is aligned with the bore 87 in the shoulder 85 of the sleeve 81 and a fastener such as a screw 101 is threaded into the bore 87 a sufficient distance to extend into the channel 73 to lock the handle 61 to the casing 35. The cam 95, carried by the handle 61, retains the casing 35 on the ball support 5. The handle 61 can be rotated in the sleeve 81 to move the cam 95 axially forwardly or rearwardly, the channel 73 on the handle 61, receiving the screw 101, wide enough to permit limited axial movement of the handle.

The casing 35 has an interior groove 105 in its upper part-spherical portion 45. A resilient o-ring 107 is mounted into the groove 105 to project slightly past the inner surface 109 of the casing 35 into the interior of the casing. The groove 105 is parallel with the top opening 49 in the casing 35 and is located closer to the top than the bottom of the upper portion 45.

In use, a PC or other electronic device is detachably mounted on the top mounting plate 51 with suitable mounting means (not shown). The user then rotates the handle 61, on its longitudinal axis to withdraw the handle slightly from the casing 35, unlocking the ball 29 and thus the mounting plate 51 for movement. As the handle 61 is slightly withdrawn from the cam groove 17 in the ball support 5, the casing 35 is free to move slightly upwardly, raising the o-ring 107 off the surface of the ball 29. This allows the user to move the mounting plate 51 with one hand to a desired rotational position and a desired angle at this rotational position, the ball 29 supporting the plate 51 rolling and rotating in the ball support 5 within the casing 35 during movement. The angular position of the plate, relative to the horizontal, is limited by the plate 51 contacting the peripheral edge of the top 47 of the casing 35. The hole 49 is made large enough; the casing 35 curved inwardly at the top enough; and the extension 31 high enough; to allow the plate 51 to tilt a sufficient amount to locate the device on the plate at a suitable angle for the operator to view it. It has been found, when the unit is used in vehicles that a tilt up to about thirty degrees from the horizontal is sufficient. The withdrawn handle 61, and the casing 35, can rotate three hundred and sixty degrees about the vertical axis of the support 1 to a desired position.

Once the device on the mounting plate 51 is in the desired position, the user rotates the handle 61 in the opposite direction to cause the cams to move the casing 35 down to lock the ball 29 against movement with the o-ring 107 and thus lock the plate 51 against any movement. As the handle 61 is rotated to move inwardly, the cam 95 on the pin 91 in the head 63 moves into the cam slot 17 and is cammed downwardly by the angled side 97 of the cam 95 riding on the angled side 23 of the slot 17. As the pin 91 is cammed downwardly, the attached handle 61 and attached casing 35 move down with it.

When the casing 35 moves downwardly, the o-ring 107 that it carries on the inner surface 109 of the upper semi-spherical portion 45 bears against the surface of the ball 29 to prevent its movement. The support is now locked against both tilting movement of the support plate 51 and rotational movement of the handle 61 about the ball support 5. The upward-downward movement required is incremental-no more than a sixteenth of an inch. It will be seen in FIG. 4 that the bottom 39 of the casing 35 does not quite reach bottom 15 of the ball support 5 when the casing is released from the ball 29. Thus there is room to cam the casing 35 down to have the o-ring 107 tightly grip the ball 29 preventing its movement.

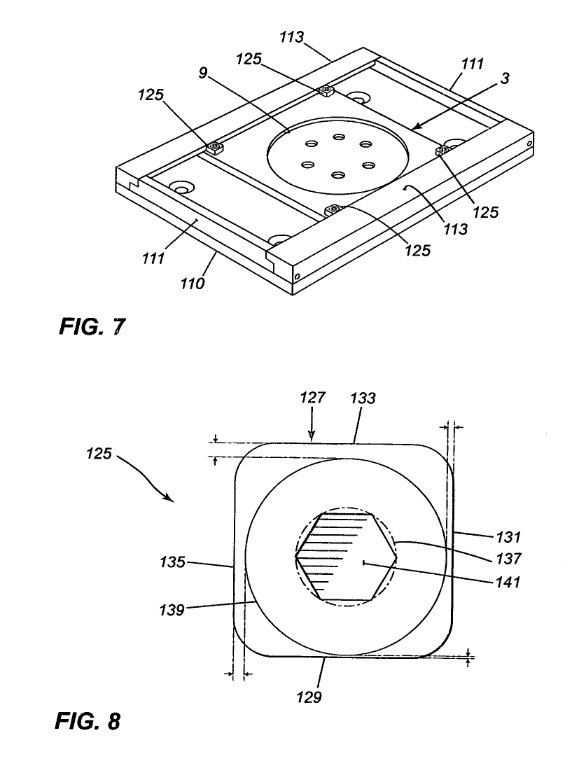

The bottom plate 3 is slidably mounted on a base 110. The base 110 has a rectangular shape with end rails 111 mounted at the narrow ends of the base. The end rails 111 are joined to side rails 113 extending along the long sides of the base 110. The side rails 113 are undercut on their inner side 115 to provide slots 117 to slidably receive opposed sides of the bottom plate 3 of the support 1. One end rail 111 is removable to slide the bottom plate 3 onto the base 110 between the side rails 113. The bottom plate 3 is relatively loose in the slots 117. The square bottom plate 3, as shown in FIGS. 7 and 8, mounts guide members 125 on its top surface 11 at its four corners. Two guide members 125 bear against each side rail 113, as shown in FIG. 1, to guide the bottom plate 3 for longitudinal movement between the side rails 113. The fit between the guide members 125 and the side rails 113 is snug enough to prevent minimal lateral movement of the plate 3 relative to the rails 113 while still permitting the plate 3 to slide along the base 110.

The guide members 125 are identical so only one will be described in detail. Each guide member 125 is a relatively thin, square block 127 with four sides 129, 131, 133, and 135. The block 127 has a central opening 137 for receiving a screw 139 to detachably connect the block 127 to the bottom plate 3. The opening 137 in the block is offset so that the distance between the center 141 of the opening 137 and the sides 129, 131, 133 and 135 of the block varies, the distance increasing in equal increments from shortest distance to the longest distance. A first side 129 is the shortest distance from the center and a second, adjacent side 131 is the second shortest distance from the center. The fourth side 135 opposite the second side 131 is the third shortest distance from the center and the third side 133 opposite the first side 129 is the longest distance from the center. The block is suitably marked in a manner to indicate the relative distance of each side from the center of the opening relative to the other sides. Each block 127 is first mounted with its side 129 nearest to the center of the opening 137 closest to the side rail 113.

As the device is used, the one side 129 of the blocks wears down very slightly sliding along the rail and the bottom plate 3 becomes very slightly loose between the side rails 113. Since the support is intended to be mainly used with vehicles, the motor of the vehicle, when running, can cause vibration in the support making it difficult to read the device on the support if the bottom plate 3 becomes loose on the base 110. To tighten the plate, the guides 125 are each rotated a quarter turn on the bottom plate 3 to place a second side 131 of the guides 125, that is slightly farther away from the center 141 of the opening 139 than the first side 129 against the side rail. Since the sides 131 of the guides 125 are now farther apart, the plate is more tightly held between the rails. The process can be repeated as the plate loosens to bring the fourth side 135 into use and then the third side 133.

The handle 61 can be used to position the support 1 longitudinally in the base 110 between the end rails 111, sliding the support on its bottom plate 3. If desired, spring biased stops can be located at spaced points along the length of the base 110 on the inside of the side rails 113 to enter depressions formed in the sides of the bottom plate 3 riding in the slots 117. The stops would hold the support in the desired selected position along the length of the base plate.

I claim:

1. An adjustable support for supporting a device, the support having: a fixed cylindrical ball support, the top of the ball support having a part-spherical depression; a ball on the top of the ball support resting snugly in the depression; a casing having a lower cylindrical portion and an upper, partial-enclosing, portion, the lower portion snugly covering the ball support and the upper portion covering at least part of the ball and normally, in a locked position of the casing, retaining the ball on the ball support so the ball cannot move; an opening in the top of the upper portion of the casing, the device to be supported connected to the top of the ball through the opening; the casing slidable on the ball support; cooperating cam means on the ball support and casing, movement of one cam means relative to the other causing movement of the casing; and cam moving means for moving the one cam means to be able to move the casing, and thus the upper portion of the casing away from its locked position on the ball to an unlocked position, allowing the ball to move thereby allowing rotation and/or tilting of the device supported by the ball.

2. An adjustable support as claimed in claim 1 wherein the cam moving means comprise a handle extending radially from the casing, the handle movable radially, relative to the casing, toward or away from the ball support and carrying one of the cam means.

3. An adjustable support as claimed in claim 1 wherein the upper portion of the casing has a groove in its inner surface below the top opening, the groove parallel to the bottom of the ball support, and an o-ring mounted in the groove and slightly protruding therefrom to bear against the ball when the casing is in a locked position, the o-ring moving away from the ball when the casing moves to its unlocked position to allow the ball to move.

4. An adjustable support as claimed in claim 2 wherein the ball support carries the other cam means in the form of a groove encircling the ball support, the groove having an angled top surface forming the other cam means, the one cam means on the handle having an angled surface slidable on the angled top surface.

5. An adjustable support as claimed in claim 4 wherein the handle is mounted through the casing, and moving the handle radially in one direction will slide the angled surface on the handle upwardly on the top angled surface on the ball support, thereby raising the casing to unlock the ball.

6. An adjustable support as claimed in claim 5 wherein the handle has a cylindrical threaded head, the head threaded through the casing, the head carrying a replaceable pin having a truncated conical end providing the angled surface of the one cam means.

7. An adjustable support as claimed in claim 6 including detachable locking means locking the head of the handle in the casing to prevent its inadvertent removal while permitting limited radial movement of the of the handle when the handle is rotated.

8. An adjustable support as claimed in claim 4 wherein the handle and casing can be rotated about the ball support to reposition the handle out of the way, when not needed, if desired, the one cam means on the handle sliding about the ball support in the groove forming the other cam means.

9. An adjustable support as claimed in claim 1 wherein the bottom plate is slidably mounted for longitudinal movement on a base, the base having parallel side walls, the bottom plate having opposed sides and guide means on each side abutting the side walls, each guide means comprising a thin block with a circular hole extending through the block, and a screw extending through the hole into the bottom plate to attach the block flat onto the top of the bottom plate; the center of the hole offset with respect to the center of the block to allow adjustment of the block to maintain contact with the sidewall.

10. An adjustable support as claimed in claim 9 wherein each block is a square with two blocks on each said side of the bottom plate, the center of the hole offset to have a first side closest to the center of the hole, a second adjacent side next closest, a fourth side opposite the second side third closest, and the third side opposite the first side the farthest from the center of the hole.

11. An adjustable support having a bottom plate; a ball support mounted on the bottom plate, the top of the ball support dished; a ball rotatably supported on the top of the ball support; a casing enclosing the ball support and the ball with a top portion of the ball extending upwardly through a hole in the top of the casing; a mounting means fixed to the top of the ball above the casing for receiving a device to be supported; a manipulating handle on the casing extending outwardly radially therefrom, the handle operatively connected with the ball support; and cooperating cam means on the handle and ball support; whereby movement of the handle in the casing toward the ball support will have the cam means move the casing against the ball to lock the ball and thus the mounting means against movement, and movement of the handle in the casing away from the ball support will move the cam means to allow the casing to move away from the ball allowing movement of the ball and thus of the mounting means.

12. Adjustable guide means for guiding a bottom plate slidably along a base, the base having two opposed side walls, the bottom plate having guide means on each of two opposed sides of the plate abutting the side walls; each guide means comprising a thin block with a circular hole extending through the block, and a screw extending through the hole into the bottom plate to attach the block flat onto the bottom plate; the center of the hole offset with respect to the center of the block.

13. Adjustable guide means as claimed in claim 12 wherein each block is square with two blocks on each said side of the bottom plate, the center of the hole offset to have a first side closest to the center of the hole, a second, adjacent side next closest, a fourth side opposite the second side third closest, and the third side opposite the first side the farthest from the center of the hole.

14. An adjustable support as claimed in claim 1 wherein the bottom plate is square and slidably mounted for longitudinal movement on a plate, the base having parallel side walls, the bottom plate having a spaced-apart pair of guide means on each side abutting the side walls, each guide means comprising a square thin block with a circular hole extending through the block, and a screw extending through the hole into the bottom plate to attach the block flat onto the top of the bottom plate; the center of the hole offset with respect to the sides of the block to have a first side closest to the center of the hole, a second adjacent side next closest, a fourth side opposite the second side third closest, and the third side opposite the first side the farthest from the center of the hole.
